(19) United States
(12) Patent Application Publication
(10) Pub. No.: US 2013/0035837 A1
(43) Pub. Date: Feb. 7, 2013

(54) MODULE AND A METHOD PERTAINING TO MODE CHOICE WHEN DETERMING VEHICLE SPEED SET-POINT VALUES

(71) Applicants: Oskar Johansson, Stockholm (SE); Jörgen Hansson, Hagersten (SE); Maria Södergren, Segeltorp (SE); Henrik Pettersson, Segeltorp (SE)

(72) Inventors: Oskar Johansson, Stockholm (SE); Jörgen Hansson, Hagersten (SE); Maria Södergren, Segeltorp (SE); Henrik Pettersson, Segeltorp (SE)

(21) Appl. No.: 13/639,660

(22) PCT Filed: Mar. 30, 2011
(86) PCT No.: PCT/SE2011/050362

§ 371 Date: Oct. 22, 2012

(30) Foreign Application Priority Data
Apr. 8, 2010 (SE) 1050333-2

(51) Int. Cl. G05D 13/02

(52) U.S. Cl. 701/98

(57) ABSTRACT

A module for determining speed set-point values V_{ref} for a vehicle's control system that includes a mode choice unit for setting of a driving mode from among at least two selectable driving modes each comprising a unique set of settings which affect the calculation of V_{ref}; a horizon unit adapted to determining a horizon from location data received and map data for an itinerary made up of route segments and at least one characteristic for each segment; and a processor unit adapted to calculating V_{ref} for the vehicle's control system along the horizon on the basis of settings for chosen driving modes and rules pertaining to categories in which segments within the horizon have been placed, so that V_{ref} is within a range bounded by Vₘᵢₙ and Vₘₐₓ.

### FIELD OF THE INVENTION

The present invention relates to a module and a method for determining speed set-point values for a vehicle's control system according to the independent claims.

### BACKGROUND TO THE INVENTION

Many vehicles today are equipped with a cruise control to make them easier to drive. A desired speed can then be set by the driver, e.g. via a control device in the steering wheel console, and a cruise control system in the vehicle thereafter causes a control system to accelerate and brake the vehicle in order to maintain the desired speed. If the vehicle is equipped with an automatic gear change system, it changes gear in such a way that the vehicle can maintain the desired speed.

When a cruise control is used in hilly terrain, the cruise control system will try to maintain a set speed uphill. This results inter alia in the vehicle accelerating over the crest of a hill and possibly into a subsequent downgrade, before subsequently being braked to avoid exceeding the set speed. This is a fuel-expensive mode of driving.

By varying the vehicle's speed in hilly terrain it is possible to save fuel as compared with a conventional cruise control. This may be done in various ways, e.g. by calculations of the vehicle's current state (as with Scania Ecocruise®). If an upgrade is calculated, the system then accelerates the vehicle uphill. Towards the end of the climb, the system is programmed to avoid acceleration until the gradient has levelled out at the top, provided that the vehicle's speed does not drop below a certain level. Lowering the speed at the end of a climb makes it possible to regain it on a subsequent downgrade without having to use the engine to accelerate. When the vehicle approaches the bottom of a dip, the system endeavours to use the kinetic energy in order to begin the next climb at a higher speed than an ordinary cruise control. The system provides slight acceleration at the end of the downgrade to maintain the vehicle's momentum. In undulating terrain, this means that the vehicle begins the next climb at a higher than normal speed. Fuel can be saved by avoiding unnecessary acceleration and utilising the vehicle's kinetic energy.

Equipping the vehicle with GPS and map data with topology information makes it possible for an economical cruise control to be provided with information about running resistances ahead. The vehicle's reference speed can thus be optimised for different types of road in order to save fuel.

Different drivers often have different needs and wishes with regard to how the cruise control should behave in order specifically to suit them, e.g. a driver may not wish to concentrate always on saving fuel but may wish instead to have shorter driving times.

Patent EP0838363 describes a method and device for controlling the speed of a vehicle by using a conventional or adaptive cruise control. The driver can change the way the vehicle behaves by altering limit values in the cruise control with regard to how much the vehicle may accelerate or retard, and thereby switch between sport mode and comfort mode.

The object of the invention is to propose an improved system for controlling a vehicle's speed which increases the driver's acceptance of the vehicle's cruise control and which in particular caters for running resistances ahead.

### SUMMARY OF THE INVENTION

The object described above is achieved by a module for determining speed set-point values v_{ref} for a vehicle's control system, comprising a mode choice unit for setting a driving mode, chosen for example by the vehicle's driver from among at least two selectable driving modes each comprising a unique set of settings which affect the calculation of v_{ref}. The module further comprises a horizon unit adapted to determining a horizon by means of location data received and map data for an itinerary made up of route segments and at least one characteristic for each segment, and a processor unit adapted to calculating v_{ref} for the vehicle's control system along the horizon on the basis of settings for chosen driving modes and rules pertaining to categories in which segments within the horizon have been placed, so that v_{ref} is within a range bounded by lower and upper limit values vₘᵢₙ and vₘₐₓ, and the control system regulates the vehicle according to these set-point values.

The object is achieved according to another aspect by a method for determining speed set-point values v_{ref} for a vehicle's control system, comprising receiving a mode choice from among at least two selectable driving modes, chosen for example by the vehicle's driver, each of which comprises a unique set of settings which affect the calculation of v_{ref}, and determining a horizon by means of location data received and map data for an itinerary made up of route segments and at least one characteristic for each segment, and calculating v_{ref} for the vehicle's control system along the horizon on the basis of settings for chosen driving modes and rules pertaining to categories in which segments within the horizon have been placed, so that v_{ref} is within a range bounded by vₘᵢₙ and vₘₐₓ, and the control system regulates the vehicle according to these set-point values.

The fact that the driver can him/herself affect how the vehicle's speed is to be maintained, by choosing between various driving modes, enables him/her to match the vehicle's behaviour with traffic density, road type or his/her temperament, thereby increasing driver acceptance of using the system. For example, it is sometimes desirable to have shorter driving time instead of driving in a fuel-economising way, in which case the driver can change driving mode to set the vehicle to shorter driving time.

For example, an economical mode which may result in large variations in the vehicle's speed might be changed to normal mode because the traffic density has increased. Large variations in the vehicle's speed might otherwise cause irritation to other road users. Normal mode is more like a traditional cruise control, resulting in a more acceptable mode of driving during high traffic density. By change of driving mode, the vehicle can change permissible speed range, gearshift points for the automatic gear system, permissible acceleration levels etc.

The fact that a driving mode covers a number of settings makes it easier for the driver to set the vehicle in such a way as to achieve a certain driving effect, instead of having to effect each setting individually.

When the vehicle's speed is predicted to rise above or drop below predetermined thresholds round the set-point set speed selected by the driver, the algorithm tries to adjust the reference speed (i.e. the speed which the module applies to the vehicle's cruise control) on preceding segments (nearer to the vehicle) of the horizon within the indicated range vₘᵢₙ-vₘₐₓ.

Preferred embodiments are described in the dependent claims and the detailed description

### BRIEF DESCRIPTION OF THE ATTACHED DRAWINGS

The invention is described below with reference to the attached drawings, in which:

FIG. 1 depicts the module's functional incorporation in the vehicle according to an embodiment of the invention.

FIG. 2 is a flowchart of steps which the module is adapted to performing according to an embodiment of the invention.

FIG. 3 illustrates the length of a control system's horizon in relation to the length of the itinerary for the vehicle.

FIG. 4 illustrates the various vehicle speeds which are predicted and the segment categories which are continuously updated as new segments are progressively added to the horizon.

### DETAILED DESCRIPTION OF PREFERRED EMBODIMENTS OF THE INVENTION

Information about a vehicle's itinerary can be used to regulate its reference speed v_{ref} for the cruise control in the vehicle when using it to save fuel, increase safety and enhance comfort. Other set-point values for other control systems may also be regulated. Topography greatly affects the control of, in particular, the power train of heavy vehicles, since much more torque is required uphill than downhill and to make it possible to climb some hills without changing gear.

The vehicle is provided with a positioning system and map information, and location data from the positioning system and topology data from the map information are used to construct a horizon which represents the nature of the itinerary. In the description of the present invention, GPS (Global Positioning System) is indicated for determining location data for the vehicle, but other kinds of global or regional positioning systems are also conceivable to provide vehicle location data, e.g. systems which use radio receivers to determine the vehicle's location. The vehicle may also use sensors to scan the surroundings and thereby determine its location.

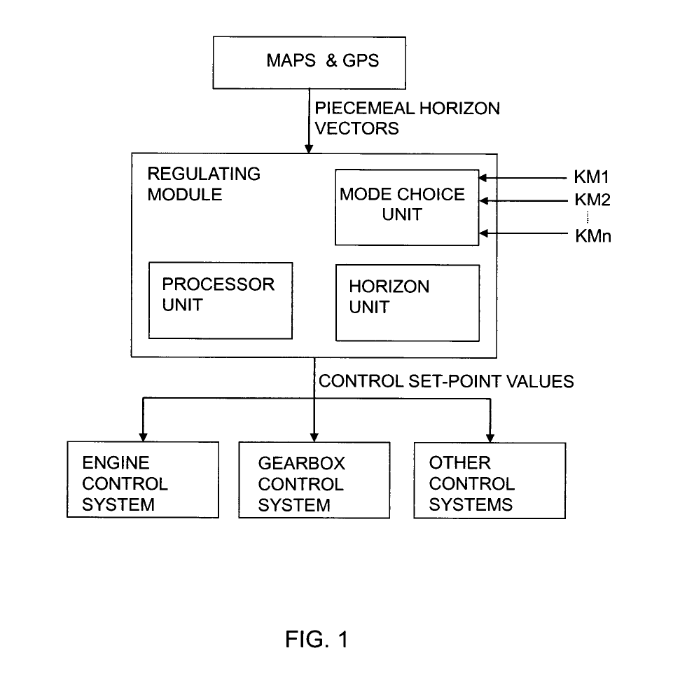

FIG. 1 illustrates how a module according to the invention incorporates map and GPS information about the itinerary. The itinerary is exemplified below as a single route for the vehicle but it should be appreciated that various conceivable itineraries are incorporated as information via maps and GPS or other positioning systems. The driver may also register the starting point and destination point for the intended journey, in which case the unit uses map data etc. to calculate a suitable route. The unit with maps and positioning system may alternatively be part of a system which is to use the regulating set-point values. The itinerary or, if there are two or more possible alternatives, the itineraries are sent bit by bit via CAN (controller area network), a serial bus system particularly suited to vehicles, to a module for regulation of set-point values. In the regulating module, the bits are put together in a horizon unit to construct a horizon and are processed by a processor unit to create an internal horizon on which the control system can regulate. If there are two or more alternative itineraries, a similar number of internal horizons are created for the various alternatives. The control system may be any of the various control systems in the vehicle, e.g. engine control system, gearbox control system or other control system. A horizon is usually constructed for each control system, since control systems regulate on different parameters. The horizon is then continually supplemented by new bits from the unit with GPS and map data to maintain a desired length of horizon. The horizon is thus updated continuously when the vehicle is in motion.

CAN is a serial bus system specially developed for use in vehicles. The CAN data bus makes digital data exchange possible between sensors, regulating components, actuators, control devices, etc. and provides assurance that two or more control devices can have access to the signals from a given sensor in order to use them to control components connected to them.

The present invention relates to a module for determining speed set-point values v_{ref} for a vehicle's control system, which module is schematically illustrated in FIG. 1.

The module comprises a mode choice unit adapted to setting of a driving mode, chosen for example by the vehicle's driver from among at least two selectable driving modes each comprising a unique set of settings which affect the calculation of v_{ref}. The various driving modes appear in FIG. 1 as KM1, KM2 . . . KMn, and there may thus be a number n of driving modes for the driver to choose from.

The module further comprises a horizon unit adapted to determining a horizon by means of location data received and map data for an itinerary made up of route segments and at least one characteristic for each segment, and a processor unit adapted to calculating v_{ref} for the vehicle's control system along the horizon on the basis of settings for chosen driving modes and rules pertaining to categories in which segments within the horizon have been placed, so that v_{ref} is within a range bounded by vₘᵢₙ and vₘₐₓ, and the control system regulates the vehicle according to these set-point values.

The result is a module which can be used in a vehicle to set the calculations of v_{ref} according to the driver's wishes. He/she makes a mode choice, e.g. by operating a control device, and thereby sets various parameters and/or functions. This means that he/she need not effect a number of settings separately, as they can be effected by a single mode choice. As the settings are specifically selected to achieve a desired effect, the driver needs no expert knowledge to be able to set the vehicle so that it is regulated as desired. The module may be part of a control system whose set-point values it is intended to regulate, or be a freestanding module independent of the control system.

vₛₑₜ is the set speed selected by the driver and desired to be maintained by the vehicle's control system when in motion within a range. The range is bounded by two speeds vₘᵢₙ and vₘₐₓ. According to a preferred embodiment, the mode choice defines the width of the range between vₘᵢₙ and vₘₐₓ, which thus define the limits about vₛₑₜ between which v_{ref} is allowed to vary. The mode choice then causes the processor unit to carry out instructions which set the width of the range between vₘᵢₙ and vₘₐₓ. It is thus possible to set the range within which v_{ref} is allowed to vary, and consequently how fuel-economisingly the vehicle is to be driven. A large range provides scope for larger fuel savings than a smaller range. According to an embodiment the range is asymmetrical about vₛₑₜ. If the larger portion of the range is below vₛₑₜ, more fuel saving is possible, since v_{ref} is allowed to drop more. If the larger portion of the range is above vₛₑₜ, there is scope for shorter driving time, since v_{ref} is allowed to rise more, allowing higher average speed. Four different range width settings are defined here as “maximum range width”, “medium range width”, “minimum range width” and “even range width”. The range depends on the set speed chosen by the driver and is preferably a percentage of the set speed. In this example, ranges are defined as absolute values. The “maximum range width” is between 13 and 20 km/h, e.g. −12 and +3 km/h round 80 km/h. The “medium range width” is between 6 and 12 km/h, e.g. −8 and +3 km/h round 80 km/h, and the “minimum range width” is between 0 and 5 km/h, e.g. 0 and +5 km/h round 80 km/h. The “even range width” is between 2 and 16 km/h and is evenly distributed about v_{ref}, e.g. −5 and +5 km/h round 80 km/h. Other values are nevertheless possible and those given here are merely examples.

According to an embodiment, the mode choice defines the acceleration and/or retardation by which the vehicle's speed is allowed to be adjusted. The mode choice causes the processor unit to set the acceleration and retardation by which the speed is allowed to be adjusted and it is thus possible to have as much comfort as may be desired, to the detriment of fuel saving, and vice versa. The comfort criterion thus limits the permissible acceleration and/or retardation for the vehicle. Three different acceleration and retardation settings are defined here as “maximum permissible acceleration and/or retardation” of between 1 and 3 m/s², “medium permissible acceleration and/or retardation” of between 0.5 and 1 m/s², and “minimum permissible acceleration and/or retardation” of between 0.02 and 0.5 m/s². Other values are nevertheless possible and those given here are merely examples. According to an embodiment, the ranges are also weight-dependent, which means that “maximum permissible acceleration and/or retardation” and “medium permissible acceleration and/or retardation” will be the same for a heavy vehicle in certain situations, since during drag torque or maximum engine torque the vehicle cannot respectively apply more than medium retardation or medium acceleration in such situations. There may also be physical limitations affecting the ranges.

According to an embodiment, a desired speed increase or decrease is ramped by applying Torricelli's equation (1) to calculate the constant acceleration and retardation at which the vehicle is to be driven, provided that this acceleration and/or retardation is permissible. The mode choice therefore defines limits for both, so that desired comfort is achieved.

Torricelli's equation (1) reads

vₛₗᵤₜ²=vᵢ²+2·a·s (1)

where vᵢ is the vehicle's initial speed in a segment, vₛₗᵤₜ its speed at the end of the segment, a the constant acceleration/retardation and s the length of the segment. Chosen driving modes may also define settings in other systems in the vehicle, e.g. settings in its automatic gear choice system, and the processor unit then causes these settings to be effected.

Various functions which may be set to achieve different effects are described above. Each driving mode KM1 . . . KMn comprises a unique set of settings and we describe below some examples of conceivable driving modes which have different effects depending on their respective settings which determine how the vehicle is driven. These driving modes are here called Economy, Comfort, Power and Normal.

Economy driving mode comprises settings which make the vehicle's running behaviour more economical, e.g. maximum range width between vₘᵢₙ and vₘₐₓ and/or acceleration and/or retardation which from a fuel economy perspective are the largest permitted, e.g. medium permissible acceleration and/or retardation. Large range widths between vₘᵢₙ and vₘₐₓ make it possible to save more fuel on undulating roads with substantial hills by increasing the possibility of utilising the vehicle's potential energy and kinetic energy on downhill runs. A driver who chooses Economy may thus take larger variations in the vehicle's speed in order to save fuel. According to an embodiment, the speed range is limited so that the vehicle's speed may only be lowered in order to give more priority to fuel than to driving time. In Economy, the acceleration and/or retardation, a in Torricelli's equation (1), may therefore be greater. Reference speed down-ramping by applying Torricelli's equation (1) may be replaced by throttling the fuel injection, as explained below, to achieve time-effective driving of the vehicle. The driver is assumed to be receptive to poorer comfort for the sake of fuel saving. According to an embodiment, the downshift points in automatic gear choice systems are moved to lower engine speeds so that downshifts occur less frequently, and the gear can be used more by changing gear at higher engine speeds in order thereafter to take gear changes of two or three steps more frequently.

Comfort driving mode comprises settings which make the vehicle's running behaviour more economical without detracting from comfort, e.g. medium range width between vₘᵢₙ and vₘₐₓ, which is a smaller range than in Economy, and medium permissible acceleration and/or retardation, i.e. a value of a in Torricelli's equation (1) which results in comfort and is lower than the value applied in Economy. In this case the automatic gear choice system is in normal mode.

Power driving mode comprises settings which make the vehicle's running behaviour more powerful, e.g. minimum range width between vₘᵢₙ and vₘₐₓ, and/or allows maximum permissible acceleration and/or retardation. The driver is assumed to wish to feel the “power” in the vehicle and, unlike other modes, less priority is attached to fuel saving than to time. Acceleration and retardation depend here on engine performance and vehicle weight. The automatic gear choice system is preferably also set to change gear in hilly terrain, which means the vehicle running at a generally higher engine speed.

Normal driving mode comprises settings which make the vehicle's running behaviour economical and comfortable, with range width evenly distributed about the set speed vₛₑₜ. It is here assumed that the driver wishes to have both comfort and fuel saving, so the range about the set speed may for example be −5 and +5 km/h round 80 km/h. In this case the automatic gear choice system is preferably in normal mode.

It is also possible to have settings which make the vehicle achieve shorter driving times without increasing its fuel consumption. These settings may be incorporated in, for example, Power mode or be catered for by a mode of their own. The speed range vₘᵢₙ−vₘₐₓ will then be such that priority is given to speed increases before uphill runs, which is advantageous for driving time, whereas before steep downhill runs the speed will be lowered albeit slightly to avoid having to brake downhill. The fuel supply may for example be throttled when speed lowering is to be applied. Throttling the fuel supply may for example be effected by lowering the reference speed v_{ref} in such a large step that the engine produces drag torque. The trigger point for the fuel injection throttling to begin is chosen such that desired lowering to the entry speed vᵢ in a segment is achieved, provided that it is possible. The processor unit in the module then calculates when the fuel injection to the engine has to begin to be throttled, and sends appropriate set-point values to the control system when it is time to throttle the fuel supply. The driving mode may thus define the way in which a lowering of vehicle speed is to be effected in order to avoid unnecessary braking. Throttling the fuel supply increases the vehicle's spot speed as compared with ramping its speed down by, for example, applying Torricelli's equation (1). Speed increases (acceleration of the vehicle) may be ramped before steep climbs, in which case the vehicle will not lose as much spot speed uphill as it would if it did not increase speed before the climb. Driving the vehicle in this way makes it possible to reduce driving time without increasing fuel consumption.

The shorter driving time may nevertheless be converted to less fuel consumption by lowering the vehicle's average speed.

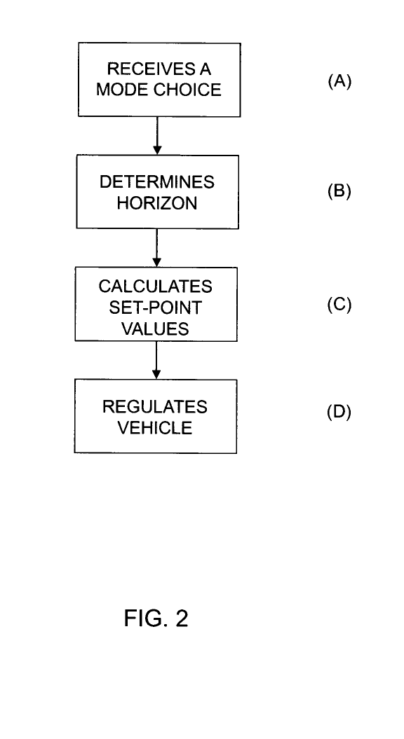

FIG. 2 is a flowchart schematically illustrating method steps according to the invention. We refer below to an example with only one horizon, but it should be appreciated that more horizons for various alternative itineraries may be constructed in parallel.

The method comprises A) receiving a mode choice from among at least two selectable driving modes each comprising a unique set of settings which affect the calculation of v_{ref}, B) determining a horizon by means of location data received and map data for an itinerary made up of route segments and at least one characteristic for each segment, C) calculating v_{ref} for the vehicle's control system along the horizon on the basis of settings for chosen driving modes and rules pertaining to categories in which segments within the horizon have been placed, so that v_{ref} is within a range bounded by vₘᵢₙ and vₘₐₓ, and D) the control system regulating the vehicle according to these set-point values.

The result is a method which increases the driver's acceptance of the vehicle's cruise control, since he/she can him/herself choose what effects the cruise control is to have.

When the vehicle is in motion, the horizon module puts the bits together progressively to construct a horizon of the itinerary, the length of the horizon being typically of the order of 1 to 2 km. The horizon unit keeps track of where the vehicle is and continually adds to the horizon so that its length is kept constant. According to an embodiment, when the destination point for the journey is within the length of the horizon, the horizon is no longer added to, since travelling beyond the destination point is not relevant.

The horizon is made up of route segments which have one or more inter-related characteristics. The horizon is here exemplified in matrix form in which each column contains a characteristic for a segment. A matrix covering 80 m ahead on an itinerary might take the following form:

$$[ \begin{matrix}dx , & \% \\ 20 , & 0.2 \\ 20 , & 0.1 \\ 20 , & - 0.1 \\ 20 , & - 0.3\end{matrix} ]$$

where the first column is the length of each segment in metres (dx) and the second column the gradient in % of each segment. The matrix is to be taken to mean that for 20 metres ahead from the vehicle's current location the gradient is 0.2%, followed by 20 metres with a gradient of 0.1%, and so on. The values for segments and gradients need not be expressed in relative values but might instead be expressed in absolute values. The matrix is with advantage vector-formed but might instead be of pointer structure, in the form of data packages or the like. There are various other conceivable characteristics, e.g. radius of curvature, traffic signs, sundry hindrances etc.

According to an embodiment the processor unit is adapted to placing segments within the horizon in various categories and to calculating threshold values for said at least one characteristic of segments, depending on one or more vehicle-specific values, and these threshold values serve as boundaries for division of segments into different categories. In the example where the characteristics of segments are gradients, threshold values are calculated for their gradients. The threshold values for the relevant characteristic are calculated, according to an embodiment of the invention, by one or more vehicle-specific values, e.g. current transmission ratio, current vehicle weight, the engine's maximum torque curve, mechanical friction and/or the vehicle's running resistance at current speed. A vehicle model internal to the control system is used to estimate running resistances at current speed. Transmission ratio and maximum torque are known magnitudes in the vehicle's control system, and vehicle weight is estimated on-line.

The following are examples of five different categories in which segments may be placed when their gradients are used for taking decisions about the control of the vehicle:

Level road: Segment with zero gradient±a tolerance.

Steep upgrade: Segment too steep for vehicle to maintain speed in current gear.

Gentle upgrade: Segment with gradient between tolerance and threshold value for sharp upgrade.

Steep downgrade: Segment so steep downhill that vehicle is accelerated by gradient alone.

Gentle downgrade: Segment with downward gradient between negative tolerance and threshold value for sharp downgrade.

According to an embodiment of the invention, the characteristics of segments are their length and gradient, and placing them in the categories described above involves calculating threshold values in the form of two gradient threshold values lₘᵢₙ and lₘₐₓ/where lₘᵢₙ is the minimum gradient for the vehicle to be accelerated downhill by gradient alone, and lₘₐₓ the maximum gradient on which the vehicle can maintain speed uphill without changing gear. Thus the vehicle may be regulated according to the gradient and length of the road ahead so that it can be driven in a fuel-economising way by means of cruise control in undulating terrain. In another embodiment, the characteristics of segments are their length and lateral acceleration, and threshold values are calculated in the form of lateral acceleration threshold values which classify segments by how much lateral acceleration they cause. The vehicle's speed may then be regulated so that it can be driven in a way suited to fuel economy and traffic safety with regard to road curvature, i.e. any speed reduction before a bend is as far as possible effected without use of service brakes. For example, the tolerance for the “level road” category is preferably between −0.05% and 0.05% when the vehicle travels at 80 km/h. On the basis of the same speed (80 km/h), lₘᵢₙ is usually calculated to be of the order of −2 to −7%, and lₘₐₓ usually 1 to 6%. However, these values depend greatly on current transmission ratio (gears+fixed rear axle ratio), engine performance and total weight.

Next, the characteristics, in this case the gradient, of each segment are compared with the calculated threshold values, and each segment is placed in a category on the basis of the comparisons. There might instead or in addition be for example similar classification by radius of curvature of the road, whereby bends might be classified by how much lateral acceleration they cause.

After each segment within the horizon has been placed in a category, an internal horizon for the control system can be constructed on the basis of the classification of segments and the horizon, comprising for each segment entry speeds vᵢ which the control system has to aim at. According to an embodiment, a speed change demanded between two entry speeds vᵢ is ramped in order to provide the control system with set-point values v_{ref} which effect a gradual increase or decrease of the vehicle's speed. Ramping a speed change results in progressive calculation of speed changes which have to be made in order to achieve the speed change. In other words, ramping results in a linear speed increase.

The entry speeds vᵢ, i.e. set-point values for the vehicle's control system, are calculated along the horizon according to settings for chosen driving modes and rules pertaining to the categories in which segments within the horizon have been placed. All the segments within the horizon are stepped through continuously, and as new segments are added to the horizon the entry speeds vᵢ are progressively adjusted in them as necessary, within the range of the vehicle's reference speed v_{ref}. The vehicle is then regulated according to the set-point values, which in the example described means that the engine control system in the vehicle regulates the vehicle's speed according to the set-point values.

The various rules for the segment categories thus regulate how the entry speed vᵢ to each segment is to be adjusted. If a segment has been placed in the “level road” category, no change will take place in the entry speed vᵢ to it.

If a segment has been placed in the “steep upgrade” or “steep downgrade” category, the end speed vₛₗᵤₜ for it is predicted by solving equation (2) below:

vₛₗᵤₜ²=(a·vᵢ²+b)·(e^{(2·a·s/M)}−b)/a (2)

in which

a=−C_{d}·ρ·A/2 (3)

b=F_{track}−Fᵣₒₗₗ−Fₐ (4)

F_{track}=(T_{eng}·i_{final}·i_{gear}·μ_{gear})/r_{wheel} (5)

Fᵣₒₗₗ=flatCorr·M·g/1000·(C_{rrisoF}+C_{b}·(vᵢ−vᵢₛₒ)+C_{aF}·(vᵢ²−vᵢₛₒ²)) (6)

F_{α}=M·g·sin(arc tan(α)) (7)

flatCorr=1/\sqrt{(1+r_{wheel}/2.70)} (8)

where C_{d} is the air resistance coefficient, ρ the density of the air, A the vehicle's largest cross-sectional area, F_{track} the force acting from the engine torque in the vehicle's direction of movement, Fᵣₒₗₗ the force from the rolling resistance acting upon the wheels, F_{α} the force acting upon the vehicle because of the gradient α of the segment, T_{eng} the engine torque, i_{final} the vehicle's final gear, i_{gear} the current transmission ratio in the gearbox, μ_{gear} the efficiency of the gear system, r_{wheel} the vehicle's wheel radius, M the vehicle's weight, C_{aF} and C_{b} speed-dependent coefficients related to the rolling resistance of the wheels, C_{rrisoF} a constant term related to the rolling resistance of the wheels and vᵢₛₒ an ISO speed, e.g. 80 km/h.

On segments in the “steep upgrade” category, the end speed vₛₗᵤₜ is thereafter compared with vₘᵢₙ and if vₛₗᵤₜ<vₘᵢₙ, then vᵢ has to be increased by Δvᵢₙ, where

Δvᵢₙ=min(vₘₐₓ−vᵢ,vₘᵢₙ−vₛₗᵤₜ) (9)

If Δvᵢₙ is zero or negative, there is no change in vᵢ.

On segments in the “steep downgrade” category, the end speed vₛₗᵤₜ is compared with vₘₐₓ, and if vslut>vₘₐₓ, then vᵢ has to be decreased by Δvᵢₙ, where

Δvᵢₙ=max(vᵢ−vₘᵢₙ,vₛₗᵤₜ−vₘₐₓ) (10)

If Δvᵢₙ is zero or negative, there is no change in vᵢ.

According to an embodiment, Torricelli's equation (1) is used to calculate whether it is possible to achieve vₛₗᵤₜ with the entry speed vᵢ with comfort requirement, i.e. with a predetermined maximum constant acceleration/retardation. This acceleration/retardation may be determined by chosen driving modes. If this is not possible because of the length of the segment, vᵢ is decreased or increased so that desired acceleration/retardation can be maintained.

On segments in the “gentle upgrade” category, the reference speed v_{ref} is allowed to vary between vₘᵢₙ and vₛₑₜ when a new segment is incorporated, i.e. vₘᵢₙ≦v_{ref}≦vₛₑₜ. If v_{ref}≧vₘᵢₙ, no acceleration of the vehicle is effected. If however v_{ref}<vₘᵢₙ, then v_{ref} is applied to vₘᵢₙ during the segment, or if v_{ref}>vₛₑₜ, then v_{ref} is ramped towards vₛₑₜ by means of equation (1). On segments in the “gentle downgrade” category, v_{ref} is allowed to vary between vₛₑₜ and vₘₐₓ when a new segment is incorporated, i.e. vₛₑₜ≦v_{ref}≦vₘₐₓ, and if v_{ref}≦vₘₐₓ no retardation of the vehicle is effected. If however v_{ref}>vₘₐₓ, then v_{ref} is applied to vₘₐₓ during the segment, or if v_{ref}<vₛₑₜ, then v_{ref} is adjusted towards vₛₑₜ, e.g. by means of equation (1). The five segment categories above may be simplified to three by omitting “gentle upgrade” and “gentle downgrade”. The “level road” category will then cover a larger range bounded by the calculated threshold values lₘᵢₙ and lₘₐₓ, so the gradient of the segment has to be smaller than lₘᵢₙ if the gradient is negative, or greater than lₘₐₓ if the gradient is positive.

When a segment which comes after a segment within the horizon which is in the “gentle upgrade” or “gentle downgrade” category causes a change in the entry speeds to segments which are in these categories, it may mean that entry speeds and hence the set-point speeds for the control system are corrected and become higher or lower than as indicated by the above rules for the “gentle upgrade or “gentle downgrade” categories. This therefore applies when the entry speeds to segments are corrected to cater for subsequent segments.

Speed changes demanded can therefore be ramped by means of Torricelli's equation (1) so that they take place with comfort requirement or, if there has to be a decrease in the speed, by throttling the fuel supply. Instead, however, a speed change may be demanded with full application of engine power as in the Power driving mode, when the driver wishes to feel the power in the vehicle. Thus it is a general rule not to raise the reference speed v_{ref} on an upgrade, since any speed increase of v_{ref} has to take place before the climb begins if the vehicle is to be driven in a cost-effective way. For the same reason, the reference speed v_{ref} should not be lowered on a downgrade, since any possible speed decrease of v_{ref} has to take place before the downhill run.

By continuously stepping through all the segments within the horizon, it is possible to determine an internal horizon which provides predicted entry values vᵢ to each segment. The internal horizon is updated continually as new segments are added to it, e.g. two to three times per second. Continuous stepping through segments within the horizon involves continuously calculating the entry values vᵢ to each segment, and this may entail having to change entry values both ahead and behind within the internal horizon. Where for example a predicted speed on a segment is outside a set range, it is desirable to correct the speed in preceding segments.

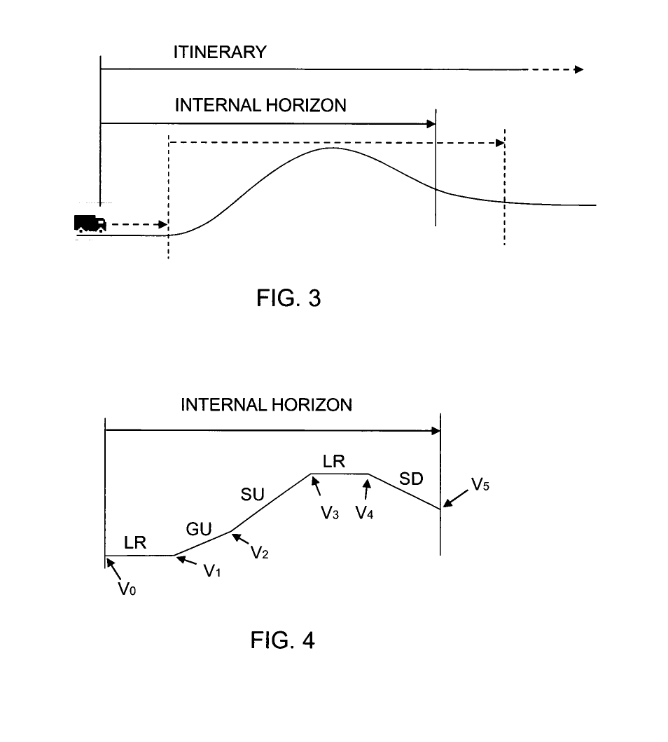

FIG. 3 depicts the internal horizon relative to the itinerary. The internal horizon moves continually ahead as indicated by the broken inner horizon moved forward. FIG. 4 depicts an example of an internal horizon in which the various segments have been placed in a category. In the diagram “LR” stands for “level road”, “GU” for “gentle upgrade”, “SU” for “steep upgrade” and “SD” for “steep downgrade”. The speed is initially v₀, and if this is not v_{set,} then the set-point values from v₀ to vₛₑₜ are generated. The next segment is a “gentle upgrade” and no change in v_{ref} takes place so long as vₘᵢₙ≦v_{ref}≦vₛₑₜ. The next segment is a “steep upgrade”, so the end speed v₃ for it is predicted by means of formula (2) and v₂ has to be increased if v₃<vₘᵢₙ according to formula (9). The next segment is “level road”, so v_{ref} is adjusted towards vₛₑₜ. Then comes a segment which is a “steep downgrade”, so the end speed v₅ is predicted by means of formula (2) and v₄ has to be decreased if v₅>vₘₐₓ according to formula (10). As soon as a speed behind within the internal horizon is changed, the remaining speeds behind within it are adjusted to be able to fulfil the speed further ahead.

The present invention comprises also a computer programme product comprising computer programme instructions for enabling a computer system in a vehicle to perform steps according to the method when the computer programme instructions are run on said computer system. The computer programme instructions are preferably stored on a medium which can be read by a computer system, e.g. a CD ROM or USB memory, or they may be transmitted wirelessly or by cable to the computer system.

The present invention is not confined to the embodiments described above. Sundry alternatives, modifications and equivalents may be used. The aforesaid embodiments therefore do not limit the scope of the invention, which is defined by the attached claims.

1. A module for determining speed set-point values V_{ref} for a vehicle's control system, the module comprising:
a mode choice unit for setting a driving mode selectable from at least two driving modes each comprising a unique set of settings which affect the calculation of V_{ref};
a horizon unit configured to determine a horizon from location data received and map data for an itinerary made up of route segments and at least one characteristic for each segment;
a processor unit configured to calculate V_{ref} for the vehicle's control system along the horizon on the basis of settings for chosen driving modes and rules pertaining to categories in which segments within the horizon have been placed, so that V_{ref} is within a range bounded by Vₘᵢₙ and Vₘₐₓ, wherein the vehicle's control system regulates the vehicle according to set-point values V_{ref}.

2. A module according to claim 1, in which the mode choice defines range widths between Vₘᵢₙ and Vₘₐₓ.

3. A module according to claim 1, in which the mode choice defines acceleration, retardation, or acceleration and retardation by which vehicle's speed is allowed to be adjusted.

4. A module according to claim 1, in which the mode choice defines the way in which a lowering of the vehicle's speed is to be effected to avoid unnecessary braking.

5. A module according to claim 1, in which chosen driving modes define settings in other systems in the vehicle.

6. A module according to claim 5, in which chosen driving modes define settings in the vehicle's automatic gear choice system.

7. A module according to claim 1, in which a driving mode comprises settings which make the vehicle's running behaviour more economical, with maximum range width between one of Vₘᵢₙ and Vₘₐₓ, medium permissible acceleration, and retardation.

8. A module according to claim 1, in which a driving mode comprises settings which make the vehicle's running behaviour more economical, without detracting from comfort, with medium range width between one of Vₘᵢₙ and Vₘₐₓ, medium permissible acceleration, and retardation.

9. A module according to claim 1, in which a driving mode comprises settings which make the vehicle's running behaviour more powerful, with minimum range width between one of Vₘᵢₙ and Vₘₐₓ, maximum permissible acceleration, and retardation.

10. A module according to claim 1, in which a driving mode comprises settings which make the vehicle's running behaviour economical and comfortable, with even range width about a set speed selected by the driver.

11. A module according to claim 1, in which the processor unit is configured to calculate threshold values for said at least one characteristic of segments, depending on one or more vehicle-specific values, which threshold values serve as boundaries for division of segments into various categories, to comparing at least one characteristic of each segment with the calculated threshold values and to placing each segment in a category on the basis of the results of the comparisons.

12. A module according to claim 11, in which vehicle-specific values are determined by one of current transmission ratio, current vehicle weight, the engine's maximum torque curve, mechanical friction, and the vehicle's running resistance at current speed.

13. A module according to claim 1, in which the horizon unit is configured to determine the horizon continuously so long as it does not go beyond an intended itinerary for the vehicle, and in which the processor unit is configured to continuously perform steps to calculate and update the set-point values for the control system for the whole length of the horizon.

14. A method for determining speed set-point values V_{ref} for a vehicle's control system, comprising:
receiving a mode choice from among at least two selectable driving modes each of which comprises a unique set of settings which affect the calculation of V_{ref};
determining a horizon from location data received and map data for an itinerary made up of route segments and at least one characteristic for each segment;
calculating V_{ref} for the vehicle's control system along the horizon on the basis of settings for chosen driving modes and rules pertaining to categories in which segments within the horizon have been placed, so that V_{ref} is within a range bounded by Vₘᵢₙ and Vₘₐₓ, wherein the vehicle's control system regulates the vehicle according to these set-point values V_{ref}.

15. A method according to claim 14, which comprises setting of range widths between Vₘᵢₙ and Vₘₐₓ.

16. A method according to claim 14, which comprises setting the acceleration, retardation, or acceleration and retardation by which vehicle's speed is allowed to be adjusted.

17. A method according to claim 14, which comprises choosing the way in which a lowering of the vehicle's speed is to be effected to avoid unnecessary braking.

18. A method according to claim 14, which comprises effecting settings in other systems in the vehicle.

19. A method according to claim 18, which comprises effecting settings in the vehicle's automatic gear choice system.

20. A method according to claim 14, which further comprises effecting settings which make the vehicle's running behaviour more economical, with maximum range width between one of Vₘᵢₙ and Vₘₐₓ, medium permissible acceleration, and retardation.

21. A method according to claim 14, which further comprises effecting settings which make the vehicle's running behaviour more economical, without detracting from comfort, with medium range width between one of Vₘᵢₙ and Vₘₐₓ, medium permissible acceleration, and retardation.

22. A method according to claim 14, which further comprises effecting settings which make the vehicle's running behaviour more powerful, with minimum range width between one of Vₘᵢₙ and Vₘₐₓ, maximum permissible acceleration, and retardation.

23. A method according to claim 14, which further comprises effecting settings which make the vehicle's running behaviour economical and comfortable, with even range width about a set speed selected by the driver.

24. A method according to claim 14, which further comprises calculating threshold values for said at least one characteristic of segments, depending on one or more vehicle-specific values, which threshold values serve as boundaries for division of segments into various categories, comparing at least one characteristic of each segment with the calculated threshold values and placing each segment in a category on the basis of the results of the comparisons.

25. A module according to claim 24, which further comprises determining vehicle-specific values of one of current transmission ratio, current vehicle weight, the engine's maximum torque curve, mechanical friction, and the vehicle's running resistance at current speed.

26. A method according to claim 14, which further comprises determining the horizon continuously so long as it does not go beyond an intended itinerary for the vehicle, and continuously performing steps to calculate and update the set-point values for the control system for the whole length of the horizon.

27. A computer program comprising computer program instructions for enabling a computer system in a vehicle to perform steps according to the method of claim 14 when the computer program instructions are run on said computer system.

28. A computer program according to claim 27, in which the computer program instructions are stored on a medium which can be read by a computer system.
